(19) United States
(12) Patent Application Publication
(10) Pub. No.: US 2013/0152437 A1
(43) Pub. Date: Jun. 20, 2013

(54) WARNING TRIANGLE FOR A MOTOR VEHICLE

(71) Applicants: Kok Eng Ng, Penang (MY); Chee Jia Chang, Penang (MY)

(72) Inventors: Kok Eng Ng, Penang (MY); Chee Jia Chang, Penang (MY)

(73) Assignee: OSRAM Opto Semiconductors GmbH, Regensburg (DE)

(21) Appl. No.: 13/805,089

(22) PCT Filed: Jun. 27, 2011
(86) PCT No.: PCT/EP2011/060743

§ 371 Date: Feb. 27, 2013

(30) Foreign Application Priority Data
Jun. 30, 2010 (DE) 10 2010 025 607.2

(51) Int. Cl. B60Q 7/00

(52) U.S. Cl. CPC B60Q 7/00
USPC 40/582; 40/541

(57) ABSTRACT

A warning triangle for a motor vehicle includes at least one light-emitting diode, which emits light when in operation, and a light guide, which guides light emitted by the light-emitting diode to a front portion of the warning triangle and to a back portion of the warning triangle.

### RELATED APPLICATIONS

This is a §371 of International Application No. PCT/EP2011/060743, with an international filing date of Jun. 27, 2011 (WO 2012/000947 A1, published Jan. 5, 2012, which is based on German Patent Application No. 10 2010 025607.2 filed Jun. 30, 2010, the subject matter of which is incorporated herein by reference.

### TECHNICAL FIELD

This disclosure relates to a warning triangle for a motor vehicle.

### BACKGROUND

A warning triangle is described, for example, in DE 20 2004 013 522 U1.

It could nonetheless be helpful to provide a warning triangle for a motor vehicle which is particularly readily visible, in particular in fog or in the dark.

### SUMMARY

We provide a warning triangle for a motor vehicle including at least one light-emitting diode which emits light when in operation and a light guide which guides the light emitted by the light-emitting diode to a front portion of the warning triangle and to the back portion of the warning triangle.

### BRIEF DESCRIPTION OF THE DRAWINGS

FIG. 1 shows a schematic, perspective view of a warning triangle according to one exemplary embodiment.

FIG. 2 shows a schematic perspective representation of a portion of the warning triangle according to the exemplary embodiment of FIG. 1.

### DETAILED DESCRIPTION

We provide a warning triangle for a motor vehicle including in particular:
at least one light-emitting diode which emits light when in operation, and
a light guide which guides the light emitted by the light-emitting diode to the front of the warning triangle and to the back of the warning triangle.

The warning triangle advantageously actively emits light not just from one side, but rather from two sides, namely from the front and from the back, which is opposite the front. The warning triangle is particular preferably configured such that the front and the back ma be oriented perpendicular to the traffic direction. To this end, the warning triangle may be positioned either directly on the street or on a vehicle.

Particularly preferably, the light guide comprises a first reflective surface and a second reflective surface, the first reflective surface guiding light from the light-emitting diode to the front of the warning triangle and the second reflective surface of the light guide guiding light from the light emitting diode to the back of the warning triangle.

The first and/or the second reflective surface of the warning triangle may be of curved construction. The curvature of the first and/or second reflective surface of the light guide is suitable in particular to deflect radiation front the at least one light-emitting diode.

The first reflective surface and the second reflective surface are preferably arranged such that they form a common edge. The common edge of the first reflective surface and the second reflective surface is particularly preferably positioned centrally over a plurality of linearly arranged light-emitting diodes.

The light guide may be arranged downstream of the light-emitting diode in the direction of emission thereof.

Particularly preferably, the warning triangle comprises a plurality of light-emitting diodes which preferably emit red light.

The warning triangle may comprise a plurality of light-emitting diodes which emit yellow light.

Particularly preferably, the warning triangle comprises a plurality of light-emitting diodes, some of which emit red light and the remainder of which emit yellow light. In this case, the light-emitting diodes which emit red light and the light-emitting diodes which emit yellow light are preferably each arranged alternately in a line.

The at least one light-emitting diode may be operated in a flashing mode.

The warning triangle may also comprise a plurality of light-emitting diodes, which may be operated in a running mode. In particular, the light-emitting diodes may be operated to give the impression of a light running around a circumferential peripheral area of the warning triangle. To this end, the light-emitting diodes are preferably arranged in a circumferential peripheral area of the warning triangle.

The at least one light-emitting diode may be mounted on a circuit board such as, for example, a printed circuit board (PCB).

An outer surface of the warning triangle may comprise raised portions. The raised portions may be bumps formed, for example, of a rubber material. These improve adhesion if the warning triangle is erected on a vehicle. The raised portions preferably fit into corresponding recesses in a stand such that the warning triangle may alternatively be erected on the ground using the stand.

The warning triangle may comprise an in-built control circuit to control the light-emitting diodes.

The light-emitting diode and/or the control circuit may be provided for electrical supply via a motor vehicle electrical system. For example, the warning triangle may connect to a terminal for a ear phone or directly to a car battery to supply the light-emitting diode and/or the control circuit with electrical energy.

Further advantageous features and further developments of the warning triangle are revealed by the examples described below in connection with the figures.

Identical, similar or identically acting elements are provided with the same reference numerals in the figures. The figures and the size ratios of the elements illustrated in the figures relative to one another are not to be regarded as being to scale. Rather, individual elements may be illustrated on an exaggeratedly large scale for greater ease of depiction and/or better comprehension.

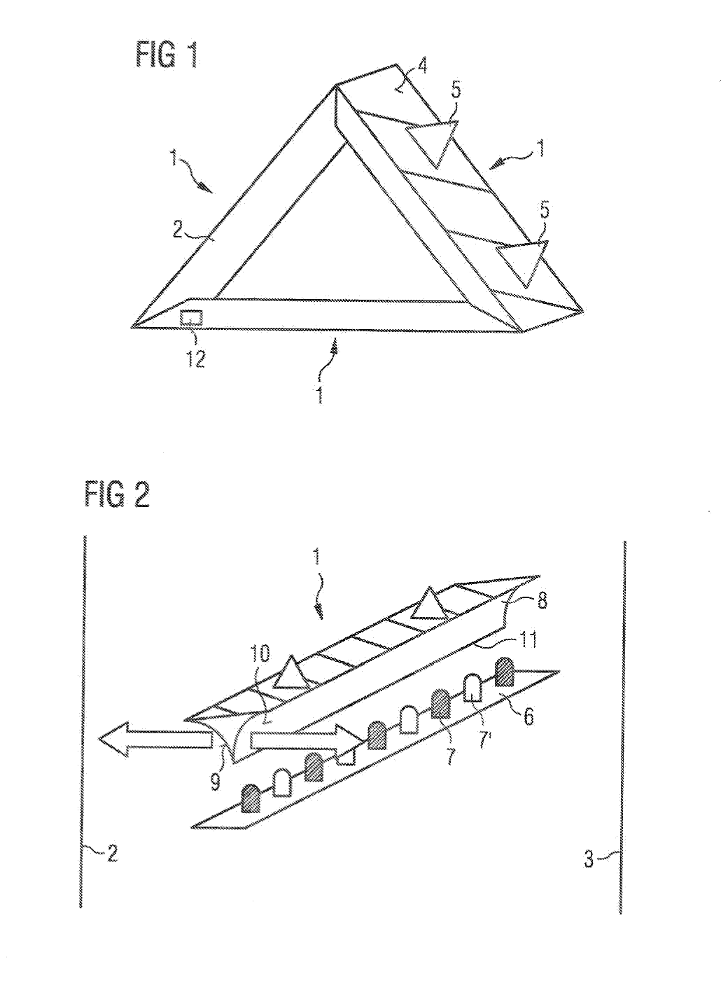

The warning triangle according to FIG. 1 comprises three legs 1 joined together to form a triangular shape. The legs 1 of the triangle form the basic framework of the warning triangle.

The warning triangle comprises a front 2 and a back 3 opposite the front 2. An outer surface 4 of the warning triangle is preferably provided with raised portions 5, for example, rubber bumps. The outer surface 4 of the warning triangle is preferably opaque.

The structure of one leg 1 of the warning triangle is shown schematically in FIG. 2. A plurality of light-emitting diodes 7, 7′ are mounted in a row on a circuit board 6. In each case, one light-emitting diode 7 which emits red light is arranged alternately with one light-emitting diode 7′ which emits yellow light. Furthermore, the spacing between the light-emitting diodes 7, 7′ is regular.

In the direction of emission, a light guide 8 is arranged downstream of the light-emitting diodes 7, 7′, which light guide comprises a first reflective surface 9 and a second reflective surface 10. The first reflective surface 9 and the second reflective surface 10 are arranged such that they are able to guide light from the light-emitting diodes 7, 7′ both to the front 2 of the warning triangle and at the same time to the back 3 of the warning triangle (see the arrows in FIG. 2).

The first reflective surface 9 and the second reflective surface 10 of the light guide 8 are of curved construction and arranged such that they form a common edge 11. The common edge 11 of the first reflective surface 9 and the second reflective surface 10 is arranged centrally over the light-emitting diodes 7, 7′.

In the example in FIG. 1, the legs 1 of the wanting triangle are each provided with a plurality of light-emitting diodes 7, 7′, as described by way of example with reference to FIG. 2. The legs 1 form a triangular shape such that the light-emitting diodes 7, 7′ are arranged within a circumferential peripheral area of the warning triangle.

The light-emitting diodes 7, 7′ may, for example, be operated in running mode in which the impression is created of a light running around within the circumferential peripheral area. Furthermore, the light-emitting diodes 7, 7′ may also be operated in flashing mode in which the light-emitting diodes 7, 7′ each light up at brief intervals.

To control the light-emitting diodes 7, 7′, the warning triangle further comprises a control circuit 12 which is preferably likewise arranged within one of the legs 1 of the warning triangle.

To supply the light-emitting diodes 7, 7′ with electrical energy, the warning triangle may, for example, connect directly to the car battery or a terminal for a car phone (not shown).

The description made with reference to examples does not restrict this disclosure to these examples. Rather, our warning triangles encompass any novel feature and any combination of features, including in particular any combination of features in the appended claims, even if the feature or combination is not itself explicitly indicated in the claims or examples.

1-14. (canceled)

15. A warning triangle for a motor vehicle comprising:
at least one light-emitting diode which emits light when in operation, and
a light guide which guides the light emitted by the light-emitting diode to a front portion of the warning triangle and to a back portion of the warning triangle.

16. The warning triangle according to claim 15, wherein the light guide comprises a first reflective surface and a second reflective surface, the first reflective surface guiding light from the light-emitting diode to the front portion of the warning triangle and the second reflective surface guiding light from the light-emitting diode to the back portion of the warning triangle.

17. The warning triangle according to claim 15, wherein the first and/or the second reflective surface of the light guide has a curved shape.

18. The warning triangle according to claim 15, wherein the light guide is arranged downstream of the light-emitting diode in a direction of emission thereof.

19. The warning triangle according to claim 15, comprising a plurality of light-emitting diodes which emit red light.

20. The warning triangle according to claim 15, comprising a plurality of light-emitting diodes which emit yellow light.

21. The warning triangle according to claim 15, comprising a plurality of light-emitting diodes, some of which emit red light and a remainder of which emit yellow light, the light-emitting diodes which emit red light and the light-emitting diodes which emit yellow light each being arranged alternately substantially in a line.

22. The warning triangle according claim 15, wherein the light-emitting diode may be operated in flashing mod

23. The warning triangle according to claim 15, comprising a plurality of light-emitting diodes which may be operated in running mode.

24. The waning triangle according to claim 15, wherein the light-emitting diode is mounted on a circuit board.

25. The warning triangle according to claim 15, wherein an outer surface of the warning triangle comprises raised portions.

26. The warning triangle according to claim 15, further comprising a built-in control circuit that controls the light-emitting diode.

27. The warning triangle according to claim 26, wherein the light-emitting diode and/or the control circuit is provided for electrical supply via a motor vehicle electrical system.

28. The warning triangle according to claim 15, wherein
a plurality of light-emitting diodes is arranged substantially in a line,
the first reflective surface and the second reflective surface are arranged to form a common edge, and
the common edge is arranged centrally over the linearly arranged light-emitting diodes.
